(19) United States
(12) Patent Application Publication
(10) Pub. No.: US 2010/0242911 A1
(43) Pub. Date: Sep. 30, 2010

(54) Combustion-supporting device of an external-combustion engine

(76) Inventors: Weu-Yu Liu, Yangmei Township (TW); Yu-Chi Ling, Yangmei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/647,247

(22) Filed: Dec. 29, 2006

(51) Int. Cl. F02M 37/00

(52) U.S. Cl. 123/434

(57) ABSTRACT

The invention is related to an improvement on a combustion-supporting device of an external-combustion engine, and Tourmaline crystal or negative charge ion producer for releasing tritium that can emit trace radioactive ray (βray) is set before air-inhaling system or fuel injection nozzle or carburetor. The feature is making use of sufficient negative charge ions produced by the foregoing negative charge ion producer to combine with oxygen gas entered fuel injection nozzle or carburetor for efficiently improving the content of air molecules and procuring the effect of more oxygen supplied to combustion; it also contains trace radiation that can make alkane and alkene molecules in fuel become smaller for easier combining with oxygen gas. The foregoing factors make the external combustion engine have better combustion efficiency, consume less fuel and emit lower concentration of waste gases.

### BACKGROUND OF THE INVENTION

1) Field of the Invention

The invention relates to improvement on a combustion-supporting device of an external-combustion engine, especially for a combustion-supporting device with concise components, which can be installed and applied easily and conveniently, and makes better combustion efficiency of external combustion engine to consume less fuel and emit lower concentration of waste gases. This unprecedented improvement on combustion-supporting device is practical, ideal and advanced.

2) Description of the Related Art

In air, nitrogen gas occupies 77% and oxygen gas occupies 21%, but the percentage of combustion-supporting gas in air is only 20%; others are hazardous gases created by pollution and most of these gases carry positive electric charge. It will not only affect combustion action, but also make oxygen, in air, carry positive charge.

The atomic weight of oxygen is 16; proton on inner part of nucleus carries 8 positive charge and the charge of neutron is zero. Hence, electron at outside need to carry 8 negative charge, and under the situation, oxygen atom is most stable. In other words, there is 2 negative charge on K level electron orbital at outer level of oxygen atom, and L level has a space for carrying 8 electrons, but only carries 6 electrons at present. Therefore, oxygen atom or molecule is very unstable, and easy to seize 2 negative charge from surroundings.

Unfortunately, under the high temperature situation caused by fuel-igniting, nitrogen gas having advantage position in air will be decomposed to become nitrogen atom; in the meantime, there are five electrons on the outmost level of orbital (L) and still have a space for three more electrons. Hence, it is easy to link up element with negative charge from surroundings, such as above-mentioned oxygen molecule. For this reason, when burning fuel, most of the oxygen gas in air will be forced to link up with nitrogen, and cause the situation of insufficient oxygen gas. Moreover, it will result in the situation of waste gas with big amount of black smoke or carbon accumulated; meanwhile, it is easy to form hazardous nitrogen compounds (NOx), such as NO, NO2 or nitrate (HNO3), which not only harm environment but also damage engine.

In addition, combustion process of an external-combustion engine is proceeding outside of cylinder; hence its heat efficiency is lower and usually need to be equipped with accessories, such as boiler or condenser, for running smoothly. The combustion room of the external-combustion engine is open; moreover, the air fuel ratio is low and this causes very low combustion efficiency. Hence, air with oxygen gas enters fuel injection nozzle or carburetor and after igniting, the fuel is burnt and creates waste gases, which contains higher concentrations of CO, hydrocarbon compound and NOx for incomplete combustion. In addition, most of the provided fuels (e.g. gasoline, diesel oil, heavy oil) are not pure chemical but an admixture contains more than 250 kinds of hydrocarbon compound and some additives. The composition of the fuel will be varied from different recovery areas, seasons and refining techniques; mostly it will contain 60˜70% alkane (direct chain, branched chain, aromatic), 5˜10% alkene (direct chain, branched chain, aromatic), and 25˜30% aromatic hydrocarbon. Hence, when an external-combustion engine is working, it will not only create abovementioned black smoke, particles, CO, hydrocarbon compounds and NOx, but also create carcinogens e.g. SOF and PAH contained in the waste gases, since the combustion process of the fuel is incomplete.

It means that the abovementioned external-combustion engine, when working, will waste fuel and create high concentration of CO, hydrocarbon compounds, organic compound (SOF) and polycyclic aromatic hydrocarbons (PAH), since combustion efficiency is low. In addition, fuel injection nozzle, carburetor and related accessories might be blocked; the acidic compounds created during combustion process will cause substantial damage on boiler, air-inhaling and gas-exhausting devices.

Then, we know that the process of burning fuel of the well-known external-combustion engine will create the foregoing disadvantages and need to be improved.

According to the foregoing factors of creating hazardous waste gases for environment, human health, engine and related devices during fuel combustion processes, the inventor knows that if supply enough negative charge ion to combustion environment, the insufficiency of electron on outer level orbital of nitrogen and oxygen can be complemented to hinder combination of nitrogen and oxygen for avoiding forming NOx, and especially make most of the oxygen be consumed on combustion process. Furthermore, the oxygen atom carrying negative charge will be easiest to combine with oil molecule, since normally oil gas will carry positive charge or be neutral; this will also support combustion processes.

### SUMMARY OF THE INVENTION

The first objective of the invention herein is to provide improvement on a combustion-supporting device of an external-combustion engine, and wherein Tourmaline crystal or negative charge ion producer for releasing tritium that can emit trace radioactive ray (βray) is set before air-inhaling system. Then, sufficient negative charge ions produced by the foregoing negative charge ion producer can improve the content of air molecules, and in the high temperature combustion room, oxygen ion can be more stable. In the meantime, other positive charge ions in air can be neutralized to avoid combining with oxygen gas for procuring the effect of more oxygen supplied to combustion to improve combustion efficiency and save fuel.

The second objective of the invention herein is to provide improvement on an combustion-supporting device of an external-combustion engine, and wherein Tourmaline crystal or negative charge ion producer for releasing tritium that can emit trace radioactive ray (βray) is set before fuel injection nozzle and carburetor, and trace radiation, provided by the foregoing negative charge ion producer, can alter fuel molecule structure to make alkane and alkene molecules in fuel become smaller for easier combing with oxygen gas; in addition, viscosity of the fuel will become lower to make instant ignition easier. Hence, combustion efficiency of the foregoing fuel will be substantially improved.

### BRIEF DESCRIPTION OF THE DRAWING

Other features and advantages of the present invention will become apparent in the following detailed description of the preferred embodiments, with reference to the accompanying drawings, in which:

FIG. 1 is a schematic plan view of the invention preferred embodiments deployed in air-inhaling duct, fuel-supplying pipe, and the deployment related to boiler and fuel tank.

FIG. 2 is a schematic view of the invention preferred embodiments set in air-inhaling duct.

FIG. 3 is a schematic view of the invention preferred embodiments set in fuel-supplying pipe.

### DETAILED DESCRIPTION OF THE PREFERRED EMBODIMENTS

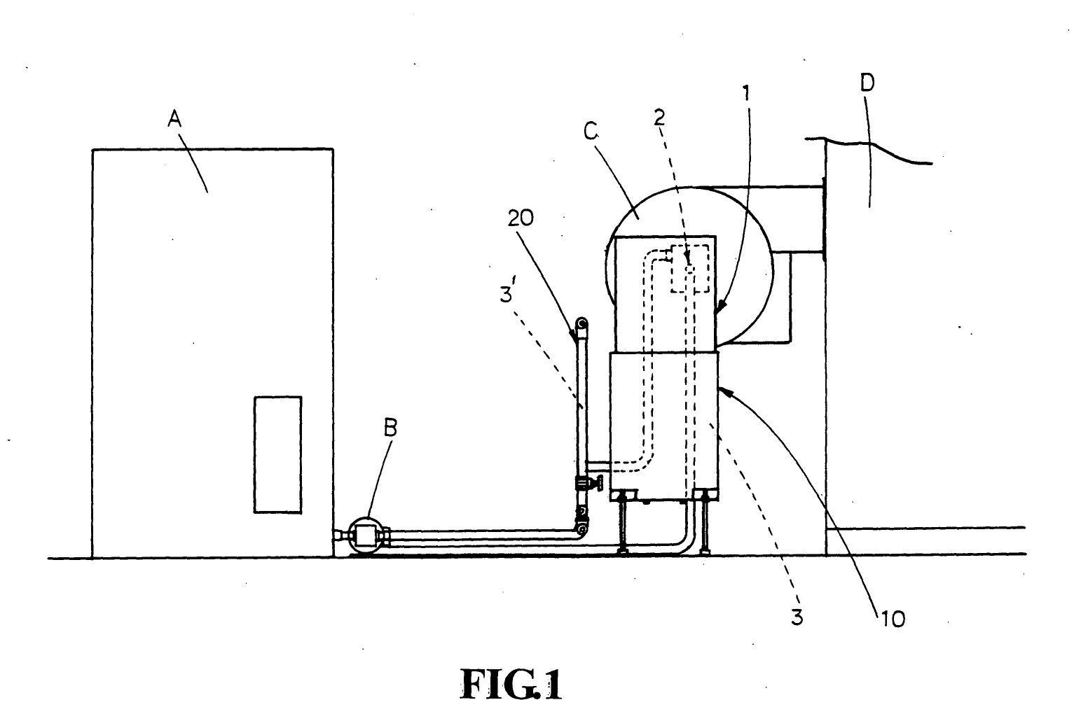

Firstly, please refer to FIGS. 1, 2 and 3. They clearly show that the invention is an improvement on an combustion-supporting device of an external-combustion engine, and mainly structured by setting negative charge ion producer 3(3′) before air-inhaling system 1 or fuel injection nozzle 2 (or carburetor); wherein the abovementioned negative charge ion producer 3(3′) can be installed at air-inhaling duct 10 or fuel-supplying pipe 20.

The foregoing negative charge ion producer 3(3′) is mainly composed of ore containing low radiation (β ray), mostly ore of rare earth elements. The foregoing ore can be grinded into fine powder and mixed with adhesive to be coated on a substrate material, or grinded into fine powder and mixed with ceramics powder to be kilned as a pearl.

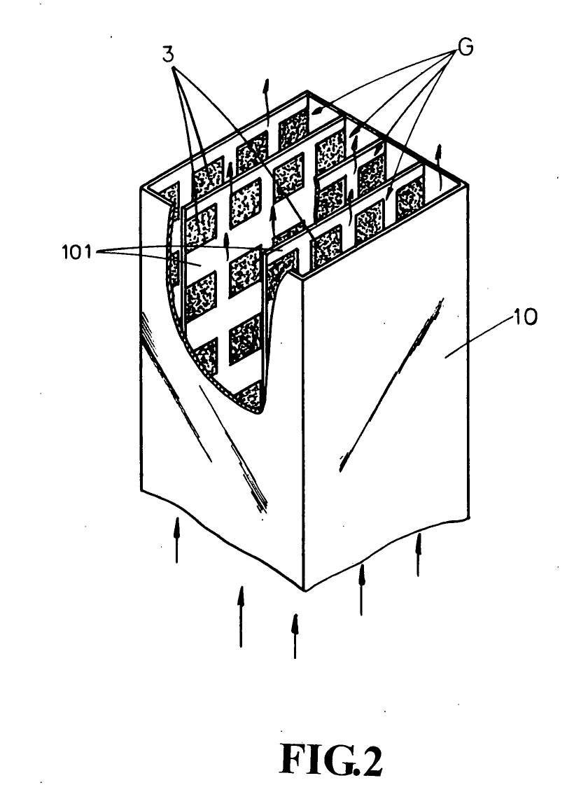

As shown on FIG. 2, flat piece negative charge ion producer 3, grinded powder coated on substrate material, can be adhered on the inside wall of air-inhaling duct 10 with predicted pieces. Since negative charge ion producer 3 can supply plenty of negative charge ions, once air flowing through its surface, negative charge ions can complement the deficiency of electrons on the outmost level of nitrogen and oxygen to make nitrogen and oxygen become more stable for avoiding their combining with each other. Hence, more oxygen can enter combustion to facilitate combustion and increase combustion efficiency.

Negative charge ion producer 3, set on the air-inhaling duct 10, can supply ions with negative charge, and the foregoing negative charge ions can enter fuel injection nozzle 2 (or carburetor) to combine with oxygen gas and cause oxygen molecule decomposed under high temperature and high pressure (no matter O⁺ or O⁻) to become more stable zero charge O, or receive a negative charge ion to form O²⁻. Moreover, such stable oxygen, passing through air-inhaling system 1 and entering combustion room, will facilitate combustion and increase combustion efficiency. Furthermore, since the foregoing ions can adsorb on fuel, when fuel sprayed out from fuel injection nozzle 2 as fuel fog, the oxygen carrying negative charge ions will sufficiently adsorb on fine fuel particle to make combustion processes become more efficient.

Negative charge ions produced by negative charge ion producer 3 which is set on the air-inhaling duct 10 can also neutralize other positive charge ions in air, and make them become zero charge for avoiding combining with oxygen gas. Hence, hazardous substances created from fuel combustion, e.g. CO, hydrocarbon compounds and NOx, will be decreased efficiently.

For assuring negative charge ion producer 3, set on the air-inhaling duct 10, to produce sufficient negative charge ions, partition the air-inhaling duct 10 with sheet materials 101 into several gas ducts G. Negative charge ion producer 3 can be installed on one surface or both surfaces of sheet materials 101 respectively; when air passing through, every negative charge ion producer 3 can supply sufficient negative charge ions.

In other words, as FIG. 1, fuel in fuel tank A passes through pump B, fuel-supplying pipe 20 and enters carburetor, fuel injection nozzle 2 to become fuel fog injected into combustion room. In addition, air also passes through air-inhaling duct 10 and air-inhaling system 1 and enters combustion room to ignite the combustion processes. Furthermore, heat source will be delivered into boiler D via blower C, and sufficient negative charge ions produced by negative charge ion producer 3, set on the air-inhaling duct 10, can directly improve the content of air molecules and procure the effect of more oxygen supplied to combustion; furthermore, other positive charge ions in air can be neutralized by negative charge ions to avoid combining with oxygen gas to form hazardous substances, e.g. CO, hydrocarbon compounds and NOx. The effect of the invention can really increase combustion efficiency of an external-combustion engine, save fuel and decrease concentration of waste gases.

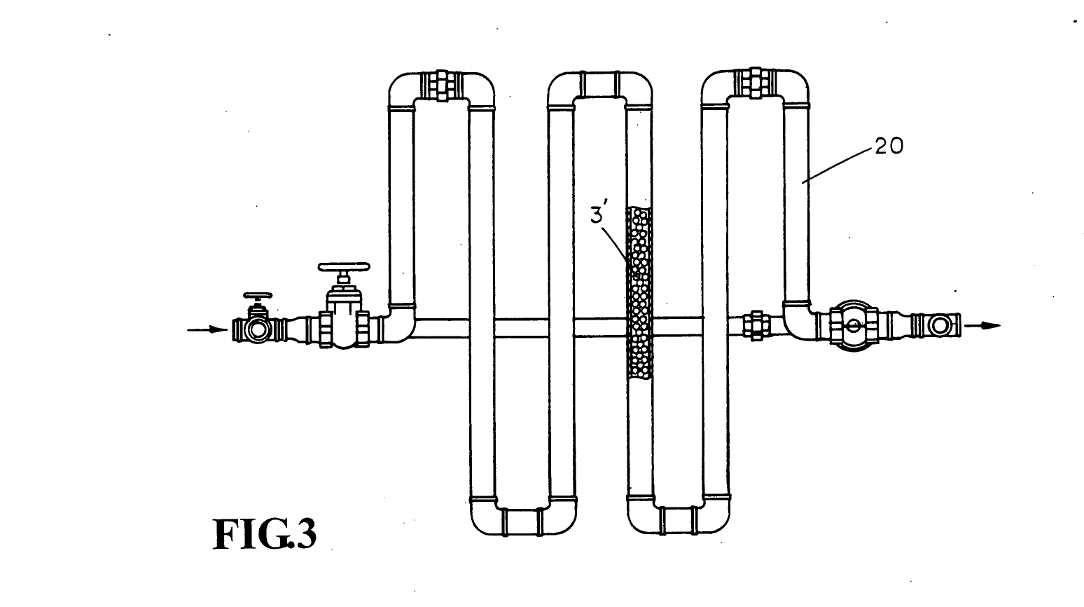

As FIG. 3, negative charge ion producer 3 made as a magnet pearl which is kilned from a mixture of ore powder of rare earth elements and ceramics powder, can be set on the inside wall of fuel-supplying pipe 20 with predicted pieces. Low radiation (β ray), contained by the foregoing negative charge ion producer, can decompose, combine (Interparticle Bridging Action) and reorganize (reorganization between polymer molecules) high molecule weight hydrocarbon compounds in fuel to alter fuel molecule structure and make molecules of alkane and alkene in fuel become smaller for easily combing with oxygen gas. In addition, viscosity of fuel can be decreased to facilitate instant ignition. Fuel, pumped by pump B, can be affected by low radiation, emitted from negative charge ion producer 3, when passing through fuel-supplying pipe 20; molecules of alkane and alkene of fuel will become smaller and cause fuel viscosity to be decreased. Moreover, when fuel passes through fuel injection nozzle 2 to become fog to enter combustion room and cooperates with inflowing air to ignite, molecules of the foregoing fuel are altered by negative charge ion producer 3 and easy to combine with oxygen gas. In addition, fuel viscosity is decreased and easy to instantly ignite. Hence, combustion of the foregoing fuel will be more efficient and fuel can be saved.

According to above description, the invention can install negative charge ion producer 3(3′) on air-inhaling duct 10 or fuel-supplying pipe 20 respectively, or on both air-inhaling duct 10 and fuel-supplying pipe 20 at the same time for requirement of practical application to procure the effect of increasing combustion efficiency, saving fuel, and decreasing concentrations of CO, hydrocarbon compounds and NOx.

What is claimed is:

1. An improvement on a combustion-supporting device of an external-combustion engine, and the feature is Tourmaline crystal or negative charge ion producer for releasing tritium that can emit trace radioactive ray (βray) is set before air-inhaling system.

2. An improvement on a combustion-supporting device of an external-combustion engine as claimed in claim 1, wherein said negative charge ion producer can be set in the air-inhaling duct.

3. An improvement on a combustion-supporting device of an external-combustion engine as claimed in claim 1, wherein said negative charge ion producer can be made by coating ore powder of rare earth elements on a substrate.

4. An improvement on a combustion-supporting device of an external-combustion engine as claimed in claim 2, wherein said several gas-supplying ducts can be partitioned by sheet materials in the foregoing air-inhaling duct, and negative charge ion producers can be installed on the surface of every sheet material for partitioning gas-supplying duct, respectively.

5. An improvement on an combustion-supporting device of an external-combustion engine, and the feature is Tourmaline crystal or negative charge ion producer for releasing tritium that can emit trace radioactive ray (βray) is set before fuel injection nozzle and carburetor of the abovementioned external-combustion engine.

6. An improvement on a combustion-supporting device of an external combustion engine as claimed in claim 5, wherein said negative charge ion producer can be installed in the fuel-supplying pipe.

7. An improvement on a combustion-supporting device of an external-combustion engine as claimed in claim 5, wherein said negative charge ion producer can be made as a magnet pearl which is kilned from a mixture of ore powder of rare earth elements and ceramics powder.
